(19) United States
(12) Patent Application Publication
(10) Pub. No.: US 2018/0067986 A1
(43) Pub. Date: Mar. 8, 2018

(54) DATABASE MODEL WITH IMPROVED STORAGE AND SEARCH STRING GENERATION TECHNIQUES

(71) Applicant: eClinicalWorks, LLC, Westborough, MA (US)

(72) Inventors: Neeraj Gupta, Grafton, MA (US); Sagar Gupta, Grafton, MA (US); Arvind Sampath, Grafton, MA (US); Girish Navani, Westborough, MA (US)

(21) Appl. No.: 15/694,120

(22) Filed: Sep. 1, 2017

Related U.S. Application Data
(60) Provisional application No. 62/383,478, filed on Sep. 4, 2016.

(51) Int. Cl. G06F 17/30

(52) U.S. Cl. CPC G06F 17/30398; G06F 17/30324; G06F 3/04842; G06F 17/30495; G06F 17/30554

(57) ABSTRACT

Systems, methods, apparatuses and computer program products are provided which utilize improved data storage and searching technique to rapidly identify records in a data collection. A database stores binary indexes which provide a condensed summary of characteristics for the records. An interface enables a search string to be generated using an interactive diagram that visually represents the search string. Selections are received via the graphical user interface to add nodes to the interactive diagram for defining the search string. The binary indexes are analyzed to quickly identify the stored records which satisfy the search string represented by the nodes added to the interactive diagram. A listing of the identified records is then made available for review and for use with various post-processing activities.

### CROSS-REFERENCE TO RELATED APPLICATIONS

The present application claims the benefit of U.S. Provisional Application No. 62/383,478 filed on Sep. 4, 2016, the contents of which is herein incorporated by reference in its entirety.

### FIELD OF THE INVENTION

The present disclosure is directed to an improved database model and, more particularly, to a database model that includes enhanced storage and retrieval capabilities and which permits users to easily define search strings using a node-based diagram.

### BACKGROUND

Various database models currently exist and are in use today. Many commercial and web-based database models utilize query languages, e.g., such as structured query language (SQL), to define search strings or queries for searching data records. Other database models, e.g., such as those associated with search engines, permit users to loosely define search strings by entering keywords into a text box on an input form.

These traditional database models are inadequate for a number of reasons. First, these models create barriers for non-technical users with respect to defining complex search strings. In many cases, the user is required to possess knowledge of a technical query language if the user desires to create a complex search string. Alternatively, if the user does not have such knowledge, the user may be permitted to search certain databases by loosely defining a search string using keywords. However, the accuracy of such keyword searches may produce results with lower precision than desired by the user.

Additionally, these traditional models are unable to process search strings utilized on large collections of records within a reasonable amount of time. Depending upon the size of the data collection, it may take several hours, or even days, to process a single search string. This is a result of the storage and retrieval techniques utilized by these database models, which tend to be expensive in terms of processing the strings and identifying relevant records in the data collection.

In view of the foregoing, there is a need for a search platform that permits non-technical users to easily define and visualize complex search queries. There is further need for such a search platform to be able to quickly process the search queries when operating on large data sets.

### SUMMARY

The inventive principles described in this disclosure relate to systems, methods, apparatuses and computerized software applications which utilize novel structures and search techniques to quickly identify relevant records included in a data collection, and novel interface techniques for defining search strings using an interactive node diagram that permits the search strings to be created and customized in a user-friendly manner. The search techniques map search criteria to binary indexes which provide condensed summaries of the record information. The binary indexes utilize binary indicators to summarize the records and permit searches to be performed quickly and efficiently. The novel interface techniques utilize a node diagram to represent a search string, and interactive features permit users to customize the diagram nodes by specifying filtering criteria and other data for defining the search string.

In accordance with certain embodiments, a system is disclosed for identifying records in a data collection. The system comprises a database that stores binary indexes, wherein each binary index comprises binary indicators which provide a condensed summary of characteristics for stored records; and a computing device having a processor and physical storage device that stores instructions. Execution of the instructions causes the computing device to: provide a graphical user interface that enables a search string to be generated using an interactive diagram that visually represents the search string; receive selections via the graphical user interface to add nodes to the interactive diagram for defining the search string; analyze the binary indexes to identify the stored records which satisfy the search string represented by the nodes added to the interactive diagram; and generate a listing of the identified records.

In accordance with certain embodiments, a method is disclosed for identifying records in a data collection. The method includes: storing binary indexes in a database stored on a non-transitory computer storage medium, wherein each binary index comprises binary indicators which provide a condensed summary of characteristics for stored records; providing a graphical user interface that enables a search string to be generated using an interactive diagram that visually represents the search string; receiving selections via the graphical user interface to add nodes to the interactive diagram for defining the search string; and analyzing the binary indexes to identify the stored records which satisfy the search string represented by the nodes added to the interactive diagram; and generating a listing of the identified records.

The foregoing and other features and advantages will become apparent from the following detailed description of illustrative embodiments thereof, which is to be read in connection with the accompanying drawings.

### BRIEF DESCRIPTION OF THE DRAWINGS

The inventive principles are illustrated in the figures of the accompanying drawings which are meant to be exemplary and not limiting, in which like references are intended to refer to like or corresponding parts, and in which:

FIG. 1 is a block diagram of a system according to certain embodiments;

FIG. 2 is a block diagram which provides a detailed view of a platform hosting device according to certain embodiments;

FIG. 3 is an illustration demonstrating how a diagram building interface can be utilized to generate search strings in accordance with certain embodiments; and

FIG. 4 is a flow chart illustrating an exemplary method for operating a search platform in accordance with certain embodiments.

The foregoing and other features and advantages will become apparent from the following detailed description of illustrative embodiments thereof, which is to be read in connection with the accompanying drawings.

### DESCRIPTION OF EXEMPLARY EMBODIMENTS

In accordance with certain embodiments, a search platform utilizes a novel database model that enables searches to be rapidly conducted on databases and/or data collections, and a novel interface that enables non-technical users to easily create and define search strings (also referred to herein as “query strings”). The interface provides an interactive, node-based diagram that visually represents the search strings using a plurality of nodes and their associated connections. Each node of the diagram is associated with certain search or filtering criteria and the search strings are dynamically generated by adding, removing or editing nodes. Each time a user submits a request to add a node to a search string, the platform instantly identifies the records which satisfy the search criteria associated with the node, and the node is appended to the diagram. The node-based diagram is able to be constructed in real-time, even when operating on very large collections of records, as a result of improved storage techniques that utilize binary indexes to provide a condensed summary of characteristics for each record. In the context of electronic health records (EHRs), the binary indexes can provide a condensed summary of characteristics for patients (e.g., which summarize the patients” medical records, demographic information, medication histories, etc.). The binary-based storage techniques enable the computations associated with adding, removing or editing nodes to be performed instantaneously, while also significantly reducing the storage space required for data that is utilized to make the computations.

To initiate the creation of a search string, a user may access an interactive graphical user interface (GUI) via the search platform, and initialize a search string by adding a head node to the diagram and specifying search criteria for the node. The search platform then identifies applicable records satisfying the search criteria and updates the visual representation of the node to indicate the search criteria and the number of matching records. The user may then select an option to add a second node to the search string. This may include specifying additional search criteria for the new node and specifying a logical connector (e.g., such as an “AND” connector, “OR” connector or any other known connector) indicating the node's relationship to the first node of the search string. The search platform again identifies any applicable records satisfying the search criteria of the search string and updates the diagram to include the new node and its associated connector.

At this point, the search string is represented by the search criteria specified by the two nodes and the logical connector. The user may further define the search string by adding one or more additional nodes to the second node and specifying the associated search criteria and logical connectors. The user can alternatively, or additionally, define a new search string by adding a new head node and/or by creating a second search string which branches off the original head node. Nodes can be added, removed and edited according to the needs of the user, and the search platform automatically and instantly updates the information associated with the nodes using the binary-based storage and retrieval techniques discussed below. In this manner, a non-technical user can easily create and define search strings on a graphical user interface without any knowledge of complex query languages (e.g., SQL, CQL, QUEL, search engine query languages or other query language). This node-based, visual representation of a search string is easily comprehendible, and allows the user to view and interact with the applicable subset of records at each node of the search string. The records identified by the search string can be utilized in connection with a variety of different post-processing operations.

The search platform and associated database model described herein can generally be utilized to identify or retrieve records (or other types of stored electronic data or information) for any purpose or objective. In certain embodiments, the search platform may be incorporated into a medical software application which utilizes the database model to identify and retrieve electronic health records (EHRs) or other types of medical data. For example, the medical software application may utilize the database model to perform a correlation analysis for diagnosing patients and/or generating patient care plans (e.g., plans which recommend actions, medication or the like in connection with treating and/or preventing medical conditions). The medical software application can also be utilized to perform research relating to diseases, illnesses or other medical conditions (e.g., by computing and analyzing statistics relating to patient medical conditions). In other embodiments, the search platform may be utilized by a search engine to identify content of interest. For example, the search platform may be incorporated into a search engine which utilizes the database model to identify and retrieve online or locally stored content (e.g., websites or files). The search platform and/or its associated database model may be utilized in other contexts as well.

As evidenced by the disclosure herein, the inventive principles set forth in the disclosure are rooted in computer technologies which overcome existing problems in known database models and schemas, specifically problems dealing with the efficient processing of search queries and techniques for defining such search queries. Known database techniques cannot process search queries that are utilized in connection with large collections of records within a reasonable amount of time. These known techniques also make it difficult for non-technical users to create or visualize complex search queries. The inventive principles described in this disclosure provide a technical solution (e.g., which utilizes binary-based storage and retrieval techniques to process search queries, and node-based diagrams to visualize and create search queries) for overcoming such problems. This technology-based solution marks an improvement over existing computing capabilities and functionalities related to database models by improving a device's speed and ability to process search queries and by reducing the amount of storage space required to process the queries. The novel database model is designed to improve the way a computer stores and retrieves data in memory, while the interactive GUI enables search strings to be dynamically generated and visualized in real-time as a result of the improved storage techniques.

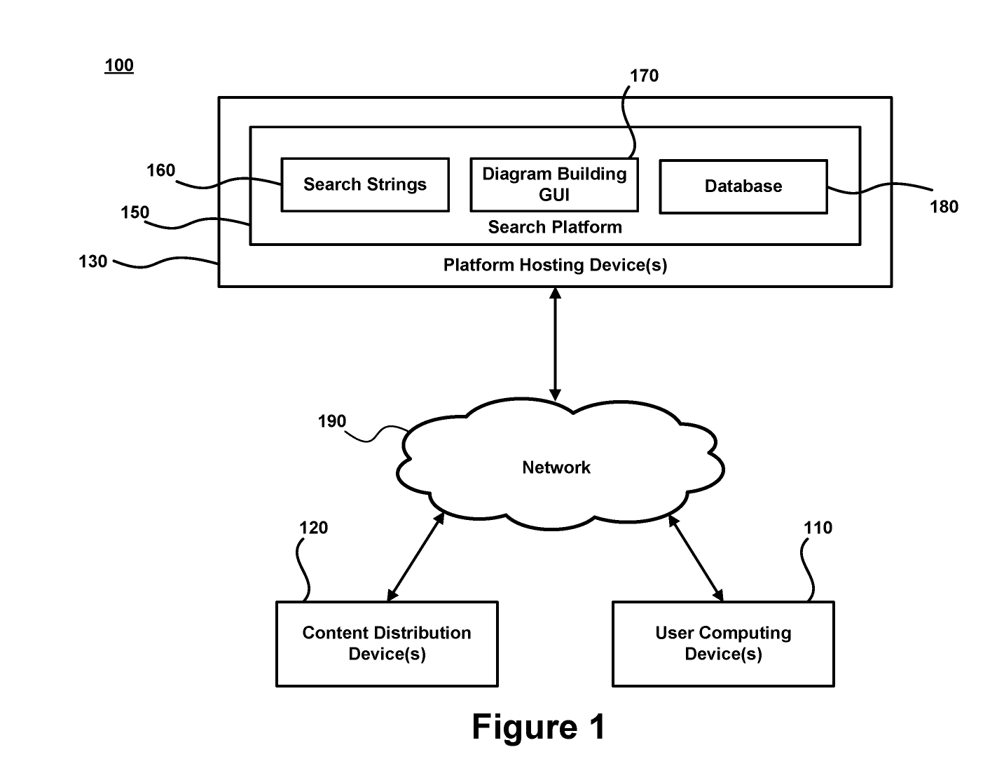

Referring now to the drawings in which like numerals represent the same or similar elements and initially to FIG. 1 which illustrates an exemplary system 100 for searching and maintaining a database in accordance with certain embodiments. The system 100 includes a user computing device 110, a content distribution device 120, and a platform hosting device 130. The user computing device 110, content distribution device 120 and platform hosting device 130 are in communication with each other over a network 190. The network 190 may be any type of network such as one that includes the Internet, a local area network, a wide area network, an intranet, a cellular network, and/or other networks. For ease of reference, FIG. 1 only shows a single computing device 110, a single content distribution device 120, and a single platform hosting device 130. However, it should be recognized that any number of user computing devices 110, content distribution devices 120, and platform hosting devices 130 may be incorporated into the system 100 and connected to the network 190, and each of the devices may be configured to communicate with one another via the network 190.

Generally speaking, the platform hosting device 130 is configured to store, provide, and/or host a search platform 150 that utilizes improved techniques for storing and maintaining a database 180, and improved techniques for generating search strings 160 to be utilized in searching the database 180. The user computing devices 110 may access the search platform 150 over the network 190 (e.g., to generate search strings 160, perform searches on the database 180 and/or utilize the search results in connection with post-processing activities). The content distribution device 120 is configured to distribute, or make available for retrieval, the content, data and/or information generated by the search platform 150.

In certain embodiments, the search platform 150 may be implemented as a local application that is installed on computing devices operated by the users of the platform (e.g., installed directly on user computing devices 110). In such embodiments, the user computing device 110 may represent a platform hosting device 130, or vice versa. In certain embodiments, the search platform 150 may alternatively, or additionally, represent a network-based, web-based and/or cloud-based platform that is accessed over a network 190 by the users using the user computing devices 110. For example, the platform hosting device 130 may represent one or more servers, or other devices, that are configured to communicate with the user computing devices 110 operated by the users.

The user computing devices 110, content distribution devices 120, and platform hosting devices 130 may represent desktop computers, laptop computers, mobile devices (e.g., cell phones, smart phones or personal digital assistants), tablet devices, server devices (e.g., mainframe server devices and/or devices with web servers), or other types of computing devices. The user computing devices 110, content distribution devices 120, and platform hosting devices 130 may be configured to communicate via wired or wireless links, or a combination of the two. Each may be equipped with one or more computer storage devices (e.g., RAM, ROM, PROM, SRAM, etc.) and one or more processing devices (e.g., central processing units) that are capable of executing computer program instructions. The computer storage devices are preferably physical, non-transitory mediums.

Regardless of whether the search platform 150 is hosted locally or remotely over the network 190, the search platform 150 is configured to provide users with one or more diagram building interfaces 170 that assist users with generating and defining search strings 160 that can be utilized to perform searches on records included in the database 180. More specifically, the diagram building interface 170 provides an interactive environment for generating search strings 160 by creating visual or graphic-based node diagrams that are used to depict and visualize the search strings 160. The diagram building interface 170 enables users to insert nodes into the diagram to specify search criteria or filtering criteria that is to be associated with the search strings 160. The search strings 160 can then be utilized to perform search operations on the database 180, and the results of the search operations can be utilized in post-processing activities (e.g., the search results can be utilized by a program or application to perform specific operations or analyses).

The creation of a search string 160 may be initiated with a selection on the diagram building interface 170 to create a new search string 160 and/or to add a head node to a diagram. The user may specify search criteria to be associated with the head node. The search criteria may be used to identify a set of records in the database which satisfy the search criteria. Once the applicable set of records is identified, a graphic-based node may be added to the diagram displayed on the diagram building interface 170. The node added to the diagram may then display information representing the status of the search string 160. For example, the node added to the diagram may indicate the number of applicable records that satisfy the search criteria associated with node, and may further indicate the search criteria that was entered. Other types of information may also be incorporated into the node to be displayed to the user.

After a head node is added to the diagram, a user can select an interactive feature on the head node (or other portion of the diagram building interface 170) to specify that a child node is to be added to the diagram which is connected to the head node. The user may specify the search criteria to be associated with the child node. The search platform 150 may then search the subset of records identified by the head node to determine which of the records further satisfy the search criteria associated with the child node. Another graphic-based node may then be added to the node diagram displayed on the diagram building interface 170. Again, the child node added to the diagram can indicate the status of the search string (e.g., by denoting the number of applicable records which match the search criteria associated with both the head node and the child node).

At this point, the user can add an additional node off of the child node and/or add another child node off of the head node. Each time a node is added, a further search is performed to identify applicable records satisfying the search criteria of the node being added, and all previous nodes included in the string. Once the applicable set of records has been identified, a graphical depiction of the node is added to the diagram which includes associated information (e.g., indicating the number of applicable records and identifying the search criteria associated with node). The process of adding nodes can continue until an appropriate set of records has identified and/or until an appropriate search string 160 has been defined by the node diagram.

In certain embodiments, each time a user adds a child node to the diagram, the user may input or select logical connectors to be applied to the node being added. For example, a user may select an “AND” connector or an “OR” connector to be applied to the child node which indicates the node's relationship to the previous node or nodes in the search string. Any known logical connector may be applied to the string. Exemplary logical connectors may include any type of logic gate including, but not limited to, the following: AND, OR, XOR, XNOR, NAND, NOR, NOT, NOR, XNOR, etc. In certain embodiments, exemplary logical connectors may further include set theory symbols including, but not limited to union symbols (∪), intersection symbols (∩), subset symbols (⊂, ⊂, or [symbol] ) and superset symbols (⊃, [symbol] or [symbol] ). The set theory symbols can be utilized to combine results of different branches of the search strings 160.

To illustrate this, consider an example in which a user (e.g., a medical practitioner/researcher) is trying to search a set of medical records to identify a subset of patients who have high-blood pressure and who also fall within one of three different age groups (i.e., 10-20 years old, 30-40 years old, or 50-60 years old). The user may seek to identify the patients in connection with a medical research project or to provide the patients with care plans. A user may initially add a head node that includes search criteria identifying all patients. The user may then add a child node that includes search criteria that identifies a subset of the patients that have high-blood pressure. In adding this node, the user may select an “AND” connector to be applied to the search criteria of the node. At this point, the user may add three grandchild nodes off of the child node, each of which specifies search criteria identifying one of the three different age groups. For each node, the user may also identify logical connector which shows the relationship among the grandchild nodes (in this example specifying an “OR” logical connector so that each child branch requires both the criteria specify the high-blood pressure and the criteria identifying a particular age group). At this point, the three branches have identified all of the relevant patients (i.e., a first branch identifies all patients with high-blood pressure between ages of 10-20 years old, a second branch identifies all patients with high-blood pressure between ages of 30-40 years old, and a third branch identifies all patients with high-blood pressure between ages of 50-60 years old). In addition, the user can add an additional node and an associated logical connector, which specifies that a union operation (“∪”) should be performed on the three patients sets associated with each branch. Thus, the additional node added to the end of the search string would identify a set a patients which satisfied the search criteria. The user can select a feature on this node to view a complete listing of patients that satisfy the search criteria. Likewise, the user can select a feature on each of the three grandchild notes to view the three separate sets of patients corresponding to the different alternatives for satisfying the search criteria.

The search platform 150 stores a set of rules and/or instructions for providing the interface for generating the user-friendly interface 170 that enables users to generate the dynamic node-based diagrams which represent the search strings 160. These rules and instructions provide the user with a set of interactive, graphic-based features on the interface 170 which allow a user to specify the search strings using basic inputs (e.g., via mouse clicks, touch gestures and/or keyboard inputs). In certain embodiments, the rules and instructions further include mapping information that associates the search criteria associated with nodes with specific binary indicators included in binary indexes to permit queries to be performed instantaneously on the database 180. In this manner, non-technical users are able to easily generate complex search strings 160 without any technical knowledge of querying languages, and the search strings 160 are presented to the users as a visual diagram that can be easily comprehended.

As mentioned above, the search platform 150 stores, or has access to, a database 180 (or a plurality of databases) which includes records and any associated information. In certain embodiments, the database 180 may be stored or located locally on the platform hosting device 130 operated by the user of the search platform 150, or may be located on one or more servers, computing devices, or storage devices which are accessible over the network 190 (e.g., one or more third party servers which can be accessed by the platform hosting device 130).

In certain embodiments, the database 180 may further store binary indexes which summarize and condense information and data for a plurality of records. The binary indexes can be generated by a pre-processing operation performed by the search platform 150 on the records in the database 180. The binary indexes are comprised of binary indicators (e.g., 1's or 0's) which represent true or false values corresponding to specific information or characteristics associated with the records in the database 180. The search platform 150 can quickly identify a subset of records matching a search criteria input by a user by analyzing the binary indicators. The search platform 150 may utilize mapping information to identify the appropriate binary indicators to analyze for determining whether the search criteria is satisfied.

In certain embodiments, the binary indexes summarize information pertaining to a plurality of individuals. For example, each binary index may correspond to a specific individual (e.g., patient) whose records are stored in the database 180. The binary index associated with an individual is comprised of a plurality of binary indicators associated with the individual or the individual's medical records. Each binary indicator represents a true or false value, or yes or no value, for a particular characteristic of the associated patient or record. When users submit requests to add search criteria to search strings (e.g., by adding or editing nodes in the diagrams), the search platform 150 retrieves the binary indexes for each of the patients and determines whether the specified search criteria is satisfied by analyzing the value assigned to a specific binary indicator (or a plurality of values of specific binary indicators) in each of the binary indexes.

For example, in certain embodiments in which the search platform 150 is integrated with a medical software application that stores and retrieves EHR records (e.g., in connection with a correlation analysis or for other purposes), the binary indicators in the binary index associated with each of the records may indicate, or be related to, any or all of the following categories and characteristics: (1) a patient's demographics (e.g., indicating a patient's age, race, ethnicity, nationality, etc.); (2) a patient's social history (e.g., indicating familial, occupational and recreational aspects of a patient's life including, but not limited to, habits relating to exercise tendencies, drug and alcohol consumption, traveling, sexual preferences and diet); (3) a patient's medical and surgical history; (4) a patient's family history; (5) a patient's chronic conditions; (6) a patient's appointment behavior (e.g., indicating how often a patient seeks medical attention or attends scheduled appointments); (7) a patient's lab test history; (8) a patient's procedural history; (9) a patient's medication history; (10) a patient's compliance details (e.g., indicating a patient's adherence with a care plan, or compliance with respect to filling or using medications); (11) a patient's emergency room admittance history; (12) a patient's hospital activity history; (13) a patient's vital statistics; (14) a patient's immunization history; (15) a patient's socio-economic data; (16) a patient's behavioral data; (17) a patient's referral pattern data; and/or (18) medical conditions of the patient (e.g., current or previous illnesses, diseases or other conditions). For each patient, the binary index may store a plurality of binary indicators for each of the aforementioned categories which are indicative of characteristics associated with each of the categories. When search criteria is added to a search string, the search platform 150 checks the applicable binary indicator (or set of binary indicators) for each patient to instantly determine whether the search criteria is satisfied. The speed at which the search platform 150 is able to process large sets of records is dramatically increased due to the underlying storage techniques which rely on the binary indexes.

After the search platform 150 determines which records satisfy the search criteria of a node being edited or added to a search string, a node is added to, or updated in, the diagram and displayed to the user. The node may include information which identifies the specified search criteria and the number of records satisfying the search criteria of the node (as well as the search criteria associated with parent nodes in the search string). The node may further include one or more interactive elements (e.g., buttons or links on an interface). One exemplary interactive element allows the user to edit the specified search criteria. Additional interactive elements may permit the user to view a listing of all applicable records or individuals which satisfy the search criteria for the node, and to add additional nodes to the search string.

In certain embodiments, in response to a user selecting the interactive element on a node which displays the applicable records satisfying the search criteria for the node, a listing of the applicable records is displayed. Each of the records is associated with an interactive element that enables the user to instantly contact the patient or individual associated with the record. For example, an interactive element may be associated with each record which enables the patient to be contacted by e-mail, text, phone, inbox message or other form of communication. Each record in the listing may also include an interactive element that enables the user to assign a care plan to one or more patients. For example, a plurality of predefined patient care plans may be stored on the search platform. Each patient care plan may include recommendations (e.g., in terms of actions, medications, etc.) to treat or prevent medical conditions. After the search platform 150 is utilized to perform a correlation analysis, the user may display the listing of applicable records matching the search criteria and select one or more of the predefined care plans to be assigned and associated with each of the patients.

In certain embodiments, the search strings 160 created on the search platform 150 can be saved and subsequently loaded by the same user that created the search string and/or other users of the search platform 150. In certain embodiments, a provider or user of the search platform 150 may allow a set of predefined search strings 160 to be downloaded by users from a platform hosting device 130 that hosts the platform 150 and/or a third party, e.g., a content distribution device 120 that distributes applications or other digital content (e.g., Apple's App Store or Google Play). The platform provider or a user of the platform may define a plurality of useful search strings 160 and the set of search strings 160 may be uploaded to a network location (e.g., associated with a content distribution device 120) to enable downloading and use of the search strings 160 by other users. For example, in the context of a medical application, an individual or company that provides the platform may define a plurality of search strings 160 that can be useful to medical practitioners, professionals, assistants, and/or entities (e.g., medical offices, hospitals, labs, etc.). The search strings can be made available for purchase and/or downloading by the content distribution device 120.

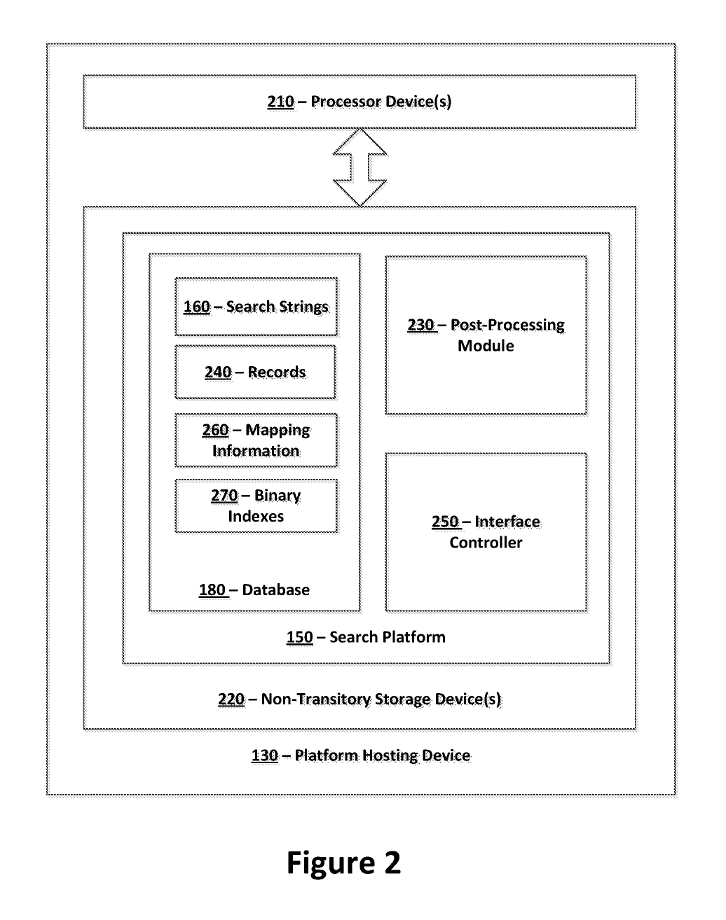

FIG. 2 is a block diagram which provides a detailed view of a platform hosting device 130 according to certain embodiments. As shown therein, the platform hosting device 130 includes a processor device 210 and non-transitory computer storage device 220. Although only one processor device 210 and only one non-transitory storage device 220 is shown for ease of reference, it should be understood that the platform hosting device 130 may include any number of processor devices 210 and any number of non-transitory computer storage devices 220.

The search platform 150 is stored on the non-transitory storage device 220. The search platform 150 includes, inter alia, instructions for implementing and executing an interface controller 250. The interface controller 250 is configured to perform any and all functions mentioned in this disclosure which relate to providing an interface that enables users to define search strings 160, perform searches on databases 180, and utilize the results of the searches in connection with other subsequent processing activities (e.g., in the medical application context, to assist with activities associated with assigning care plans, diagnosing medical conditions, conducting medical research, performing statistical analyses, and/or utilizing the search results generated by the search platform in other ways). In certain embodiments, the interface controller 250 can perform any and all activities related to generating a diagram for defining search strings 160 (e.g., adding, editing or removing nodes that are utilized to define a search string 160), saving search strings 160 to be imported for re-use at a later time or for distribution to other users, interpreting inputs from users received via the interface, translating the inputs provided by users into one or more query languages (e.g., translating the inputs into complex SQL statements or queries), utilizing the translated search strings 160 to perform search operations on database(s) 180, or any other related activities or operations.

As explained above, the search platform 150 also includes a database 180 (or a plurality of databases 180) that stores records 240. For example, in the medical application context, the records 240 may include medical information (e.g., information indicating patient medical conditions, copies of patient medical records, medication history information, surgical history information, etc.), patient information (e.g., demographic information, social habit information, etc.), and any related information. In the search engine application context, the record information 240 may comprise information related to websites (e.g., for use with an Internet search engine) or network resources (e.g., documents, files, etc.). The records 240 can vary based on the context in which the search platform 150 is be utilized.

The database 180 also stores binary indexes 270 which provide condensed summaries of the record information 240. The binary indexes comprise a plurality of binary indicators, each of which provides a binary indication (e.g., a true or false value) of a specific characteristic, trait or attribute associated data included in the record information. As explained above, in the medical application context, separate binary indexes 270 may be provided for each of a plurality of patients and each binary index 270 can include a condensed summary of the record information 240 corresponding to an associated patient. For example, the binary indicators in a binary index 270 may include a true or false value (e.g., represented by a 1 or 0) indicating whether or not a patient has been diagnosed with a particular medical condition, indicating whether or not a patient is included within a particular demographic group (e.g., within a particular age group, race group, ethnicity group, etc.), indicating whether or not a patient has undergone particular surgeries or taken particular medications, etc. In the search engine context, separate binary indexes may be provided for each of a plurality of websites, webpages, or network resources. Each binary index may include binary indicators representing whether or not the website, webpage or network resource includes certain traits. For example, the binary indicators may include true or false values indicating whether or not the website, webpage or network resource is in a particular format (e.g., such as HTML or Microsoft word), whether or not the website, webpage or network resource includes certain keywords, whether or not the website, webpage or network resource includes certain types of metadata, etc. Regardless of the context in which the search platform is being applied, the search platform 150 can analyze the binary indexes to quickly identify a subset of records which match a search string 160 defined by the node diagrams created using the diagram building interface 170.

The database 180 further stores mapping information 260 which maps and correlates search criteria or filtering criteria that is made available via the diagram building interface 170 to the binary indicators included in the binary indexes 270. The interface controller 250 utilizes the mapping information 260 to perform searches on the binary indexes 270. For example, in the medical application context, the diagram building interface 170 may permit a user to select or specify criteria for medical conditions such as type one diabetes and cancer. A specific binary indicator may indicate whether a patient has type one diabetes. Another binary indicator may indicate whether the patient has cancer (and another may indicate the specific type of cancer). The mapping information 260 can correlate the type one diabetes search criteria with the relevant binary indicator and, similarly, can correlate the cancer search criteria with the relevant binary indicator or set of binary indicators. In response to a user adding a node that specifies certain search criteria, the search platform 150 may retrieve and analyze the mapping information 260 to identify which binary indicators to inspect for determining whether the search criteria is satisfied.

The database further stores the search strings 160 generated by the diagram building interface 170. The diagram building interface 170 may include a save feature that enables a user to store one or more search strings 160 that are displayed on the diagram building interface 170 in the form of a node based diagram. In response to a user selecting the save feature, all relevant information associated with the search string 160 (e.g., the search criteria and connectors of each node, and the ordering of the nodes) can be saved in the database 180 to enable the search strings 160 to be retrieved and loaded onto the diagram building interface 170 in the form of a node-based diagram.

In certain embodiments, the search platform 150 may further include a post-processing module 230. The post-processing module 230 can include instructions for implementing any function or activity which utilizes the search results (e.g., records). For example, in the medical application context, the post-processing module 230 can load the records identified by the search strings 160 and utilize the results to conduct a medical-based correlation analysis, diagnose medical conditions, generate patient care plans (e.g., for treating or preventing medical conditions), and/or assign patient care plans to patients. In the search engine context, the post-processing module 230 can be utilized to output the set of search results to a file, transmit the search results to individuals over the network 190, and/or generate hyperlinks that enable the search results to be accessed.

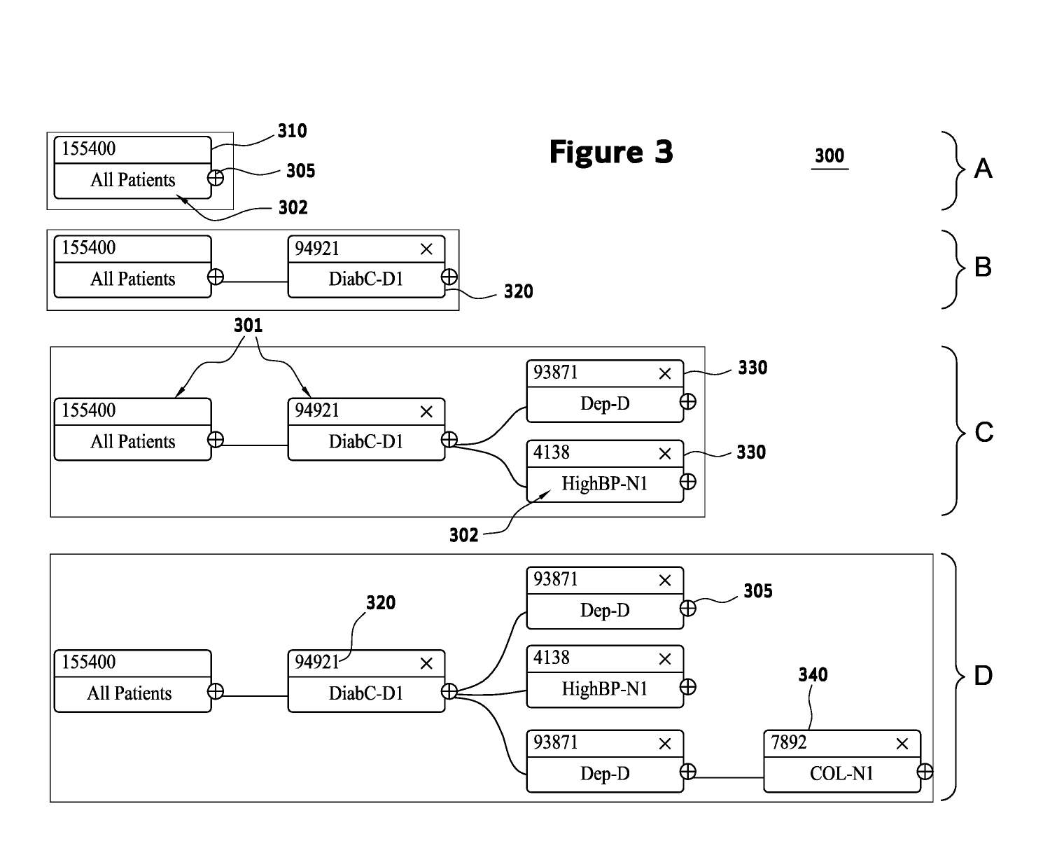

FIG. 3 is an illustration 300 demonstrating an example of how a node diagram can be created on diagram building interface 170 to define a search string in accordance with certain embodiments. In this example, the diagram building interface is built on top of a medical database which includes record information 240 that corresponds to medical records for a plurality of patients. The user in this example is building a search string for a specify query to identify (1) all patients who have type one diabetes and who either depressed or who have hypertension; or (2) all depressed patients who have type one diabetes and who have had a colonoscopy. The user desires to generate a search string 160 which can identify all patients satisfying either of these conditions.

The illustration 300 shows a search string 160 being generated in a medical application context at four stages of development: Stage A, Stage B, Stage C and Stage D.

At Stage A, the user initiated creation of the search string by adding a head node 310. The node displays the selected search criteria 302, which has been set to “All Patients” to capture all potential patients in the database 180. The node 310 includes a match indicator 301 that shows how many records satisfy the search criteria (i.e., 115,400). The node also includes an append feature 305 which enables a user to add one or more additional nodes to the search string 160.

At Stage B, the user has added a child node 320 to the search string 160 and has specified search criteria 302 to identify patients having type one diabetes (“DiabC-D1”). Specifically, in response to the user's selection of the append feature 305, the search platform 150 searched the binary indexes 270 to identify patients satisfying the search criteria 302 and updated the diagram building interface 170 to include the node 320. The user indicated that an “AND” connector should be utilized to connect the child node 320 to the head node 310. The match indicator 301 indicates that there are 94,921 patients in the database who have type one diabetes.

At Stage C, the user has added two grandchild nodes 330 off of the child node 320 (e.g., by selecting the append feature 305 twice, and specifying search criteria and corresponding “OR” logical connectors). The nodes 330 specify search criteria 302 for depression (“Dep-D”) and for hypertension (“HighBP-N1”). The match indicator 301 for the grandchild node 330 associated with the depression search criteria 302 indicates that there are 93,871 patients who satisfy the search criteria 302 (i.e., at this node, indicating the number of patients who have type one diabetes and who also have depression). The match indicator 301 for the grandchild node 330 associated with the hypertension search criteria 302 indicates that there are 4,138 patients who satisfy the search criteria 302 (i.e., at this node, indicating the number of patients who have type one diabetes and who also have hypertension). At this point, the search string 160 satisfies the first portion of the query in that it indicates all patients who have type one diabetes and who either depressed or who have hypertension.

At Stage D, the user has added a third grandchild node 330 off of the child node 320 (e.g., by selecting the append feature 305 on the child node 320) again specifying depression (“Dep-D”) as the search criteria 302, and great-grandchild node 340 connected to the child node 320. The great-grandchild node 340 specifies search criteria 302 to identify patients who have had a colonoscopy (“COL-N1”). The match indicator 301 for the newly added grandchild node 330 indicates that 93,871 patients satisfy the search criteria 302, and the match indicator 301 for the great-grandchild node 340 indicates that 7,892 patients satisfy the search criteria 302. At this point, the search string 160 also satisfies the second portion of the query in that it identifies all depressed patients who have type one diabetes and who have had a colonoscopy.

In certain embodiments, the user may further add an end node to combine the search results from the three branches of the node diagram (i.e., the 93,871 results from the first branch, the 4,138 results from the second branch, and the 7,892 results from the third branch). For example, the user may select a feature on the diagram building interface 170 to add the end node to the diagram. In doing so, the user may select the nodes on the diagram building interface 170 that are to be combined into the end node, and may select an appropriate logical connector (e.g., a union connector) to determine how the results are to be combined.

In certain embodiments, the match indicators 301 on each of the nodes are configured to be interactive such that the user may select (e.g., click on with a mouse or tap a touch screen) the match indicators 301 to view a listing of applicable patients corresponding to the node. For example, the user may select the match indicator 301 for the great-grandchild node 340 to view the listing of the 7,892 patients. The diagram building interface 170 may include a feature that allows the user to import the results into the post-processing module 230 for performing various types of operations using the results.

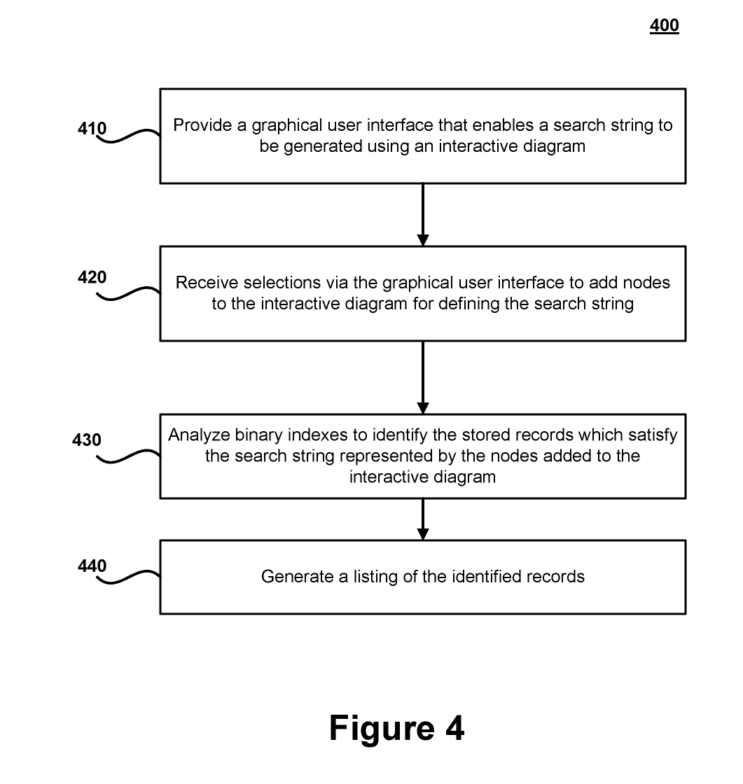

FIG. 4 is a flow chart illustrating an exemplary method 400 for defining a search string 160 utilizing the 150 search platform in accordance with certain embodiments.

In step 410, a graphical user interface (e.g., diagram building interface 170) is provided which enables a search string 160 to be generated using an interactive diagram. As mentioned above, the interface may be provided to a user locally by an application on the computing device (e.g., user device 110) operated by the user or remotely by computer device (e.g., platform hosting device 130) accessible over a network 190.

In step 420, selections are received via the graphical user interface to add nodes to the interactive diagram for defining the search string. For example, as demonstrated above with respect to FIG. 3, a user can select options on the interface to add nodes to define various criteria associated with the nodes (e.g., search criteria and logical connectors). A user can continuously add nodes until an appropriate search string 160 is represented by the interactive diagram displayed on the interface.

In step 430, binary indexes 270 are analyzed to identify the stored records which satisfy the search string 160 represented by the nodes added to the interactive diagram. As explained above, each binary index 270 can provide a condensed summary of records (e.g., a condensed summary of a patient's medical records and associated information) and various characteristics of the records can be represented with binary indicators (e.g., 0 and 1 values). The binary indexes 270 permit large collections of records to be quickly searched.

In step 440, a listing of the identified records is generated. The listing of records can be accessed by selecting an option on the interface. The identified records can then be utilized in connection with various post-processing operations (e.g., associated with assigning customer care plans or diagnosing medical conditions).

While certain portions of the foregoing disclosure may describe applications of the technologies and inventive principles in connection with medical services or software, the scope of the invention is not limited to such embodiments. Rather, the technologies and principles disclosed herein can be applied to any type of platform or service that utilizes a database to store records or other electronic information.

The embodiments described in this disclosure can be combined in various ways. Any aspect or feature that is described for one embodiment can be incorporated into any other embodiment mentioned in this disclosure. Moreover, any of the embodiments described herein may be hardware-based, software-based and, preferably, comprise a mixture of both hardware and software elements. Thus, while the description herein may describe certain embodiments, features or components as being implemented in software or hardware, it should be recognized that any embodiment, feature or component that is described in the present application may be implemented in hardware and/or software. In certain embodiments, particular aspects are implemented in software which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

While there have been shown and described and pointed out various novel features of the invention as applied to particular embodiments thereof, it should be understood that various omissions, substitutions and changes in the form and details of the systems and methods described may be made by those skilled in the art without departing from the spirit of the invention. Amongst other things, the steps in the methods may be carried out in different orders in cases where such may be appropriate. Those skilled in the art will recognize that the particular hardware and devices that are part of the system described herein, and the general functionality provided by and incorporated therein, may vary in different embodiments of the invention. Accordingly, the particular system components are provided for illustrative purposes and to facilitate a full and complete understanding and appreciation of the various aspects and functionality of particular embodiments of the invention as realized in the system and method embodiments thereof. Those skilled in the art will appreciate that the invention can be practiced in ways other than the described embodiments, which are presented for purposes of illustration and not limitation.

What is claimed is:

1. A system for identifying records in a data collection, comprising:
(a) a database that stores binary indexes, wherein each binary index comprises binary indicators which provide a condensed summary of characteristics for stored records;
(b) a computing device having a processor and a physical storage device that stores instructions, wherein execution of the instructions causes the computing device to:
provide a graphical user interface that enables a search string to be generated using an interactive diagram that visually represents the search string;
receive selections via the graphical user interface to add nodes to the interactive diagram for defining the search string;
analyze the binary indexes to identify the stored records which satisfy the search string represented by the nodes added to the interactive diagram; and
generate a listing of the identified records.

2. The system of claim 1, wherein the binary indicators comprise true or false values associated with the characteristics of the stored records, and the binary indicators are analyzed based on search criteria specified for the nodes.

3. The system of claim 1, wherein the nodes that are added to the interactive diagram display the search criteria, display a number indicating how many records match the search criteria, and include connectors that visually depict how the node is linked to other nodes in the interactive diagram.

4. The system of claim 1, wherein the interactive diagram enables a plurality of branches to be created off of each node to define the search string.

5. The system of claim 1, wherein the nodes include an interactive list generation feature that can be selected to display the listing of the records identified by the search string, and wherein the listing is provided to a post-processing module configured to utilize the identified records for certain functions or operations.

6. The system of claim 1, wherein:
the stored records include medical information associated with a set of patients;
the selections define search criteria to be associated with the nodes; and
the listing includes a set of patients having medical information that satisfies the search criteria.

7. The system of claim 6, wherein the binary indicators summarize information relating to: demographic information; social history; medical and surgical history; family history; medication history; compliance information; hospital activity history; and immunization information.

8. The system of claim 1, wherein the interactive diagram includes a feature that enables previously generated search strings to be loaded into the interactive diagram for display, and the interactive diagram is automatically populated with nodes corresponding to the previously generated search strings which are loaded into the interactive diagram.

9. The system of claim 8, wherein mapping information is stored for correlating search criteria with specific binary indicators, and the mapping information is utilized to determine which of the binary indicators are to be analyzed based on the search criteria that is specified for one of the nodes.

10. The system of claim 1, wherein each node added to the interactive diagram includes:
a first interactive element for adding a new node that branches off of the node;
a second interactive element for specifying or editing search criteria to be associated with the node; and
a third interactive element for displaying the listing.

11. A method for identifying records in a data collection, comprising:
storing binary indexes in a database stored on a non-transitory computer storage medium, wherein each binary index comprises binary indicators which provide a condensed summary of characteristics for stored records;
providing a graphical user interface that enables a search string to be generated using an interactive diagram that visually represents the search string;
receiving selections via the graphical user interface to add nodes to the interactive diagram for defining the search string;
analyzing the binary indexes to identify the stored records which satisfy the search string represented by the nodes added to the interactive diagram; and
generating a listing of the identified records.

12. The method of claim 11, wherein the binary indicators comprise true or false values associated with the characteristics of the stored records, and the binary indicators are analyzed based on search criteria specified for the nodes.

13. The method of claim 12, wherein the nodes that are added to the interactive diagram display the search criteria, display a number indicating how many records match the search criteria, and include connectors that visually depict how the node is linked to other nodes in the interactive diagram.

14. The method of claim 11, wherein the interactive diagram enables a plurality of branches to be created off of each node to define the search string.

15. The method of claim 11, wherein the nodes include an interactive list generation feature that can be selected to display the listing of the records identified by the search string, and wherein the listing is provided to a post-processing module configured to utilize the identified records for certain functions or operations.

16. The method of claim 11, wherein:
the stored records include medical information associated with a set of patients;
the selections define search criteria to be associated with the nodes; and
the listing includes a set of patients having medical information that satisfies the search criteria.

17. The method of claim 16, wherein the binary indicators summarize information relating to: demographic information; social history; medical and surgical history; family history; medication history; compliance information; hospital activity history; and immunization information.

18. The method of claim 11, wherein the interactive diagram includes a feature that enables previously generated search strings to be loaded into the interactive diagram for display, and the interactive diagram is automatically populated with nodes corresponding to the previously generated search strings which are loaded into the interactive diagram.

19. The method of claim 18, wherein mapping information is stored for correlating search criteria with specific binary indicators, and the mapping information is utilized to determine which of the binary indicators are to be analyzed based on the search criteria that is specified for one of the nodes.

20. The method of claim 11, wherein each node added to the interactive diagram includes:
a first interactive element for adding a new node that branches off of the node;
a second interactive element for specifying or editing search criteria to be associated with the node; and
a third interactive element for displaying the listing.
